(19) United States
(12) Patent Application Publication
(10) Pub. No.: US 2025/0013338 A1
(43) Pub. Date: Jan. 9, 2025

(54) MULTIMEDIA DEVICE AND METHOD FOR CONTROLLING THE SAME

(71) Applicant: LG ELECTRONICS INC., Seoul (KR)

(72) Inventors: Seungho PARK, Seoul (KR); Seungcheon BAEK, Seoul (KR)

(73) Assignee: LG ELECTRONICS INC., Seoul (KR)

(21) Appl. No.: 18/649,417

(22) Filed: Apr. 29, 2024

(30) Foreign Application Priority Data
Jul. 3, 2023 (KR) 10-2023-0085601

(51) Int. Cl. G06F 3/0481; G06F 3/0484

(52) U.S. Cl. CPC G06F 3/0481; G06F 3/0484

(57) ABSTRACT

Disclosed is a multimedia device including a display that outputs at least one skin theme, a memory storing therein a pre-specified skin theme option, a sensor that detects surrounding environment information around the multimedia device, and a controller that controls the display, the memory, and the sensor, wherein the controller controls the display to output a first skin theme corresponding to device model information, with reference to the memory, and controls the display to output a second skin theme corresponding to the surrounding environment information sensed in real time by the sensor.

### CROSS-REFERENCE TO RELATED APPLICATION

Pursuant to 35 U.S.C. § 119 (a), this application claims the benefit of earlier filing date and right of priority to Korean Patent Application No. 10-2023-0085601, filed on Jul. 3, 2023, the contents of which are hereby incorporated by reference herein in its entirety.

### BACKGROUND

### Field

The present disclosure relates to a multimedia device, and more specifically, for example, to a multimedia device that outputs a skin theme corresponding to multimedia device model information and surrounding environment information.

### Discussion of the Related Art

Recently, as technology advances, a multimedia device that can display content has become available in various fields such as a home appliance and a vehicle in addition to a television (TV).

In addition, recently, in addition to a function of simply displaying a broadcast program, an Internet function is added to the multimedia device, so that the multimedia device can perform various functions such as an e-mail and a game. Accordingly, various application icons and the like in addition to a control menu that can control the functions added to a display screen are displayed.

In this regard, the displayed screen is not only used as a means of simply providing information, but also as a tool to express individuality of a user. By applying a specific skin theme (or skin) to the screen, design elements of software can be provided to the user.

The skin refers to a theme as a graphical user interface (GUI) that can be applied to any software or website to suit tastes of different users. In other words, the skin is a term that refers to a graphic theme for each application.

In one example, as an importance of individuality expression of individuals and aesthetic interior increases, most of the multimedia devices provide a function to set the skin theme, and the skin is increasing in utilization, such as being designed and sold separately.

However, according to the prior art, as shape, feeling, and layout of the software vary depending on a product lineup or brand, there was inconvenience of having to build separate software in advance and build separate code sets and lines during a production stage. In addition, the user had to go through separate tasks such as directly searching for and purchasing the skin and changing the skin to change the feeling, the color, and the like of the software.

Moreover, not only are product models becoming more diverse, but product personalization is also becoming more important, so that a development of a skin system with high usability is required.

### SUMMARY

Embodiments are to provide a multimedia device to solve the above-described problems.

One embodiment of the present disclosure is to provide a skin system that can be applied to all devices with one software block.

In addition, another embodiment of the present disclosure is to provide a multimedia device that not only outputs a skin theme corresponding to product model information, but also outputs a skin theme corresponding to a function that can be set by an individual and a real-time environmental change.

In addition, another embodiment of the present disclosure is to provide a skin system that responds in real time to an environmental change to provide a natural change of a skin theme by improving visibility of an important component based on the environmental changes or introducing a new component to a display screen while maintaining at least some of components that have already been displayed on a device.

Technical problems to be solved in the embodiments are not limited to the technical problems mentioned above, and other technical problems not mentioned will be able to be clearly understood by those skilled in the art to which the present disclosure belongs from a description below.

A multimedia device according to one aspect of the present disclosure includes a display that outputs at least one skin theme, a memory storing therein a pre-specified skin theme option, a sensor that detects surrounding environment information around the multimedia device, and a controller that controls the display, the memory, and the sensor.

The controller controls the display to output a first skin theme corresponding to device model information, with reference to the memory, and controls the display to output a second skin theme corresponding to the surrounding environment information sensed in real time by the sensor.

In one implementation, the controller can, when the device model information is absent in the memory, receive the device model information and a third skin theme corresponding thereto via a network interface.

In one implementation, the multimedia device can further include a user interface for receiving a user command, and the controller can change at least one option in the first skin theme, based on the user command received via the user interface.

In one implementation, the sensor can include at least one of an illumination sensor or an RGB sensor.

In one implementation, the surrounding environment information can include at least one of brightness, a color value, an interior material, an interior, a temperature value, weather information, position information, or time information.

In one implementation, the controller can further include a skin system, the skin system can include an UI component block that constructs a screen, a logic block that controls user event flow, and a customize block, and the customize block can allow a user to define at least one of a font, a color, a layout, or a shape of the skin theme.

In one implementation, the controller can, when a specific event is detected by the sensor, apply an exceptional situation skin theme corresponding to the specific event.

In one implementation, the controller can prohibit at least some of options for the exceptional situation skin theme from being changed according to a user command.

In one implementation, the sensor can further include an external object sensor and an internal object sensor, and the controller can control each of the external object sensor and the internal object sensor based on a type of the multimedia device.

In one implementation, when the multimedia device is a TV, the internal object sensor can be deactivated, the external object sensor can be activated and detect a packaging color of a product, and the controller can create and apply a second skin theme corresponding to the color detected by the external object sensor.

In one implementation, the external object sensor can further detect in real time a color of a wall and a color of lighting around the multimedia device.

In one implementation, when the multimedia device is a vehicle, both the internal object sensor and the external object sensor can be activated, the internal object sensor can detect an interior color of the vehicle, the controller can create and apply a second skin theme corresponding to the color detected by the internal object sensor, the external object sensor can detect a situation outside the vehicle, and the controller can change a skin theme responding in real time to the situation detected by the external object sensor.

In one implementation, the sensor can further include a speed sensor, and when a specific event is detected by the speed sensor, the controller can apply an exceptional situation skin theme corresponding to the specific event.

A method for controlling a multimedia device according to another aspect of the present disclosure includes outputting, by a display, at least one skin theme, sensing, by a sensor, surrounding environment information around the multimedia device, controlling, by a controller, the display to output a first skin theme corresponding to device model information, with reference to a memory storing therein a pre-specified skin theme option, and controlling, by the controller, the display to output a second skin theme corresponding to the surrounding environment information sensed in real time by the sensor.

According to at least one embodiment of the present disclosure, development productivity of a manufacturer can be increased as the skin system that can be applied to all multimedia devices with the one software block is provided.

According to at least one embodiment of the present disclosure, the skin system that responds in real time to the environmental change can be provided to provide the user with a sense of luxury via the natural change of the skin theme by improving the visibility of the important component based on the environmental changes or introducing the new component to the display screen while maintaining at least some of the components that have already been displayed on the device.

According to at least one embodiment of the present disclosure, the skin system that responds in real time to the environmental change can be provided to provide a user-friendly interface, so that all devices can be personalized and a friendly and enjoyable experience can be provided to the user.

Additional scope of applicability of the present disclosure will become apparent from a detailed description below. However, because various changes and modifications within the scope of the present disclosure can be clearly understood by those skilled in the art, the detailed description and specific embodiments, such as preferred embodiments of the present disclosure, should be understood as being given by way of example only.

### BRIEF DESCRIPTION OF THE DRAWINGS

FIG. 1 is a block diagram for illustrating a multimedia device related to the present disclosure.

FIG. 2 is a block diagram showing a configuration of a skin system of a multimedia device according to an embodiment of the present disclosure.

FIG. 3 is a flowchart briefly illustrating a method for controlling a skin system according to an embodiment of the present disclosure.

FIG. 4 is a flowchart illustrating in detail a method for controlling a skin system according to an embodiment of the present disclosure.

FIG. 5 shows a simplified order of information input and output in a method for controlling a skin system.

FIG. 6 shows an example of an embodiment in which external exceptional situation information is input when a multimedia device is a vehicle in a method for controlling a skin system according to an embodiment of the present disclosure.

(a) in FIG. 7 shows a flowchart of a case in which there is a user environment exceptional situation in a method for controlling a skin system according to an embodiment of the present disclosure.

(b) in FIG. 7 shows examples of what external exceptional situation information can contain that can be input in a method for controlling a skin system according to an embodiment of the present disclosure.

FIG. 8 shows an example of a flowchart in which a skin system applies a skin when a device according to an embodiment of the present disclosure is a vehicle.

FIG. 9 shows an example of a flowchart in which a skin system applies a skin when a device according to an embodiment of the present disclosure is a television (TV).

(a) in FIG. 10 shows an example of a flowchart when real-time surrounding environment information is input in a method for controlling a skin system according to an embodiment of the present disclosure.

(b) in FIG. 10 shows examples of what real-time surrounding environment information can contain that can be input in a method for controlling a skin system according to an embodiment of the present disclosure.

### DESCRIPTION OF SPECIFIC EMBODIMENTS

Hereinafter, embodiments disclosed herein will be described in detail with reference to the attached drawings. Identical or similar components will be assigned the same reference numerals regardless of drawing numbers, and redundant descriptions thereof will be omitted.

A suffix such as “module” and “unit” of a component used in a following description is given or used interchangeably only to facilitate description of the present document, and the suffix itself is not intended to give any special meaning or function. Additionally, in describing the embodiments disclosed herein, when it is determined that detailed descriptions of related known technologies can obscure the gist of the embodiments disclosed herein, the detailed descriptions will be omitted.

In addition, the attached drawings are only for easy understanding of the embodiments disclosed herein, and the technical idea disclosed herein is not limited by the attached drawings. Further, it should be understood that the embodiments include all modifications, equivalents or substitutes included in the scope of the present disclosure.

It will be understood that although the terms first, second, etc. can be used herein to describe various elements, these elements should not be limited by these terms. These terms are generally only used to distinguish one element from another.

In addition, it will be understood that when a component is referred to as being ‘connected to’ or ‘coupled to’ another component herein, it can be directly connected to or coupled to the other component, or one or more intervening components can be present. On the other hand, it will be understood that when a component is referred to as being ‘directly connected to’ or ‘directly coupled to’ another component herein, there are no other intervening components.

As used herein, the singular forms ‘a’ and ‘an’ are intended to include the plural forms as well, unless the context clearly indicates otherwise.

It should be understood that the terms ‘comprises’, ‘comprising’, ‘includes’, and ‘including’ when used herein, specify the presence of the features, numbers, steps, operations, components, parts, or combinations thereof described herein, but do not preclude the presence or addition of one or more other features, numbers, steps, operations, components, or combinations thereof.

In one example, a multimedia device described herein is, for example, an intelligent multimedia device to which a computer support function is added in addition to a broadcast reception function. While being faithful to the broadcast reception function, because an Internet function or the like is added thereto, the multimedia device can be equipped with a more convenient interface such as a handwriting-type input device, a touch screen, an air gesture remote control, and the like. In addition, as the wired or wireless Internet function is supported, the multimedia device can access the Internet and a computer and perform functions such as e-mail, web browsing, banking, or gaming. A standardized general-purpose OS can be used for such various functions.

Therefore, in the multimedia device described in the present disclosure, various applications can be freely added or deleted on, for example, a general-purpose OS kernel, so that various user-friendly functions can be performed. More specifically, the multimedia device can be, for example, a network TV, a HBBTV, a smart TV, and the like, and in some cases, can also be applied to a refrigerator, a styler, or a vehicle.

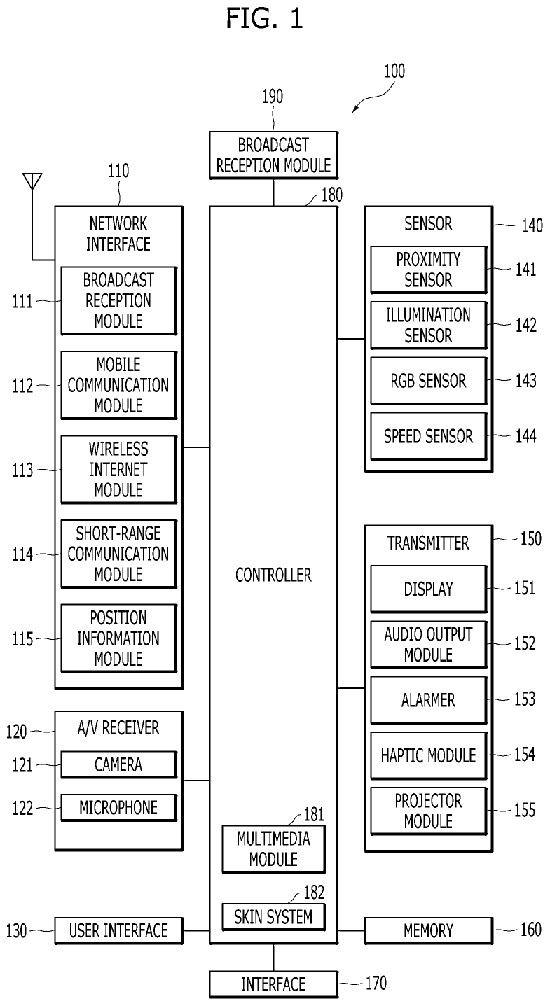

FIG. 1 is a block diagram for illustrating each component of a multimedia device related to an embodiment of the present disclosure.

The multimedia device 100 can include a network interface 110, an audio/video (A/V) receiver 120, a user interface 130, a sensor 140, an transmitter 150, a memory 160, an interface 170, a controller 180, a broadcast reception module 190, a power supply (not shown), and the like. Because the components shown in FIG. 1 are not essential, a multimedia device with more or fewer components can be implemented.

Hereinafter, the above-mentioned components will be described in detail.

The network interface 110 can include one or more modules that enable wireless communication between the multimedia device 100 and a wireless communication system or between the multimedia device 100 and a network where the multimedia device 100 is located. For example, the network interface 110 can include a broadcast reception module 111, a mobile communication module 112, a wireless Internet module 113, a short-range communication module 114, a position information module 115, and the like.

The broadcast reception module 111 receives a broadcast signal and/or broadcast-related information from an external broadcast management server via a broadcast channel.

The broadcast channel can include a satellite channel and a terrestrial channel. The broadcast signal can not only include a TV broadcast signal, a radio broadcast signal, and a data broadcast signal, but can also include a broadcast signal in a form of the TV broadcast signal or the radio broadcast signal combined with the data broadcast signal.

The broadcast-related information can mean information related to the broadcast channel, a broadcast program, or a broadcast service provider. The broadcast-related information can also be provided via a mobile communication network using the mobile communication module 112. The broadcast-related information can be in a form of an electronic program guide (EPG) of digital multimedia broadcasting (DMB), an electronic service guide (ESG) of digital video broadcast-handheld (DVB-H), or the like.

The broadcast reception module 111 can receive the digital broadcast signal using a digital broadcast system such as a digital multimedia broadcasting-terrestrial (DMB-T), digital multimedia broadcasting-satellite (DMB-S), media forward link only (MediaFLO), digital video broadcast-handheld (DVB-H), a DVB-CBMS, an OMA-BCAST, an integrated services digital broadcast-terrestrial (ISDB-T), and the like.

The broadcast signal and/or the broadcast-related information received via the broadcast reception module 111 can be stored in the memory 160.

The mobile communication module 112 transmits and receives a wireless signal to and from at least one of a base station, an external terminal, and a server on the mobile communication network. The wireless signal can include a voice call signal, a video call signal, or various types of data based on text/multimedia message transmission and reception.

Additionally, the mobile communication module 112 can download an application, a widget, and the like on an external website or a web store to the multimedia device 100.

The wireless Internet module 113 can refer to a module for wireless Internet access and can be built into or external to the multimedia device 100. As a wireless Internet technology, wireless LAN (WLAN), Wi-Fi, wireless broadband (Wibro), world interoperability for microwave access (Wimax), high speed downlink packet access (HSDPA), and the like can be used.

Additionally, the wireless Internet module 113 can download the application, the widget, and the like on the external website or the web store to the multimedia device 100.

Additionally, the wireless Internet module 113 can download device model information, a corresponding skin theme, or the like on the external website or a cloud to the multimedia device 100.

The short-range communication module 114 refers to a module for short-range communication. As a short-range communication technology, Bluetooth, radio frequency identification (RFID), infrared data association (IrDA), ultra wideband (UWB), ZigBee, and the like can be used.

The position information module 115 is a module for acquiring a position of the multimedia device, and a representative example thereof is a global position system (GPS) module. According to a current technology, the GPS module 115 can accurately calculate three-dimensional current position information based on a latitude, a longitude, and an altitude by calculating distance information and accurate time information from three or more satellites and then applying trigonometry to the calculated information. Currently, a method of calculating the location and time information using the three satellites and correcting errors in the calculated location and time information using another satellite is widely used. Additionally, the GPS module 115 can calculate speed information by continuously calculating the current position in real time.

Referring to FIG. 1, the audio/video (A/V) receiver 120, which is for inputting an audio signal or a video signal, can include a camera 121, a microphone 122, and the like. The camera 121 processes an image frame of a still image, a moving image, or the like, acquired by an image sensor in a video call mode or a shooting mode. The processed image frame can be displayed on a display 151.

The image frame processed by the camera 121 can be stored in the memory 160 or transmitted externally via the network interface 110. The camera 121 can include two or more cameras depending on a usage environment.

The microphone 122 receives an external audio signal via a microphone in a call mode, a recording mode, a voice recognition mode, and the like, and processes the audio signal into electrical voice data. When in the call mode, the processed voice data can be converted into a form that can be transmitted to a mobile communication base station via the mobile communication module 112 and output. Various noise removal algorithms to remove noise generated in the process of receiving the external audio signal can be implemented in the microphone 122.

The user interface 130 generates input data for a user to control an operation of the device.

The user interface 130 can be disposed at one side of a main body of the multimedia device 100. For example, the user interface 130 can include a touch pad, a physical button, and the like. The user interface 130 can receive various user commands related to the operation of the display device 100, and can transmit a control signal corresponding to the input command to the controller 180.

Recently, as a size of a bezel of the display device 100 has become smaller, the number of display devices 100 in which the user interface 130 in the form of physical buttons exposed to the outside has been minimized has increased. Instead, minimum physical buttons can be located on a rear surface or a side surface of the device and the user input can be received via a touch pad or a remote control device.

As described above, the user interface 130 can be composed of arrow keys, a keypad, a dome switch, the (static/electrostatic) touch pad, a jog wheel, a jog switch, and the like. The user can input setting information of the skin theme via the user interface 130.

The sensor 140 refers to a device that detects a change within the display device 100 or an external change of the device. For example, a proximity sensor, an illumination sensor, a touch sensor, an infrared sensor (IR sensor), an ultrasonic sensor, an optical sensor (e.g., a camera), an RGB sensor, a voice sensor (e.g., a microphone), a battery gauge, an environmental sensor (e.g., a hygrometer, a thermometer, and the like), an acceleration sensor, and a distance sensor.

The sensor 140 can detect a current state of the multimedia device 100, such as an open/closed state of the multimedia device 100, the position of the multimedia device 100, a presence or an absence of user contact, an orientation of the multimedia device, and acceleration/deceleration of the multimedia device, and generate a sensing signal for controlling the operation of the multimedia device 100. Additionally, the sensor 140 can sense whether power is supplied from the power supply, whether the interface 170 is connected to an external device, and the like.

The transmitter 150, which is for generating an output related to vision, hearing, or tactile sensation, can include the display 151, an audio output module 152, an alarmer 153, a haptic module 154, a projector module 155, and the like.

The display 151 displays (outputs) information processed by the multimedia device 100. A screen on which the information is displayed can be output with at least one skin theme applied. For example, when the multimedia device is in the call mode, the display 51 displays a user interface (UI) or a graphic user interface (GUI) related to the call. When the multimedia device 100 is in the video call mode or the shooting mode, the display 51 displays the shooted and/or received video, the UI, or the GUI.

The display 151 as described above can include at least one of a liquid crystal display (LCD), a thin film transistor-liquid crystal display (TFT LCD), an organic light-emitting diode (OLED), a flexible display, and a three-dimensional display (3D display).

Some of such displays can be transparent or light-transmissive such that the outside can be seen therethrough. Such display can be referred to as a transparent display, and representative examples of the transparent display can include a transparent OLED (TOLED) and the like. A rear structure of the display 151 can also be a light-transmissive structure. With such structure, the user can view an object located at the rear of the device body through an area occupied by the display 151 of the device body.

Depending on an implementation of the multimedia device 100, there can be two or more displays 151. For example, in the multimedia device 100, the plurality of displays 151 can be disposed on one surface so as to be spaced apart from each other or integrally, or can be arranged respectively on different surfaces.

When the display 151 and the sensor that detects the touch operation (hereinafter, the “touch sensor”) constitute a layered structure (hereinafter, a “touch screen”), the display 151 can also be used as an input device in addition to as an output device. The touch sensor can take a form of, for example, a touch film, a touch sheet, a touch pad, or the like.

The touch sensor can convert a change in a pressure applied to a specific portion of the display 151, a capacitance occurring in the specific portion of the display 151, or the like into an electrical input signal. The touch sensor can detect not only a location and a size of an area where the touch operation is made, but also a pressure at the time of touch.

An optimal viewing environment can be provided by controlling a content, a video quality, a size, and the like of the video provided to the display 151 differently depending on a viewer detected by the sensor, a surrounding illumination, or the like. As the smart TV advances, the number of functions installed in the display device increases, and the number of sensors 140 also increases together.

The audio output module 152 can output audio data received from the network interface 110 or stored in the memory 160 in call signal reception, the call mode or the recording mode, the voice recognition mode, the broadcast reception mode, and the like. The audio output module 152 also outputs an audio signal (e.g., a call signal reception sound, a message reception sound, and the like) related to the function performed by the multimedia device 100. Such an audio output module 152 can include a receiver, a speaker, a buzzer, and the like.

The alarmer 153 outputs a signal to notify an occurrence of an event in the multimedia device 100. Examples of the events that occur in the multimedia device include the call signal reception, the message reception, key signal input, touch input, and the like. The alarmer 153 can output a signal to notify the occurrence of the event in another form, for example, vibration, in addition to a video signal or an audio signal. Because the video signal or the audio signal can also be output via the display 151 or the audio output module 152, the display 151 and the audio output module 152 can be classified as types of alarmer 153.

The projector module 155 is a component for performing an image project function using the multimedia device 100. The projector module 155 can display a video identical to or at least partially different from the video displayed on the display 151 in response to a control signal from the controller 180 on an external screen or a wall.

The memory 160 can store a program for processing and controlling each signal by the controller 180, or can store processed video, audio, or data signal. For example, the memory 160 can store application programs designed to perform various tasks that can be processed by the controller 180, and selectively provide some of the stored application programs upon request from the controller 180. Additionally, the memory 160 can store information on a product model of the multimedia device existing in the market and a skin theme option corresponding thereto.

The programs or the like stored in the memory 160 are not particularly limited as long as they can be executed by the controller 180. The memory 160 can perform a function for temporary storage of the video, audio, or data signal received from the external device via an external device interface.

Although FIG. 1 shows the embodiment in which the memory 160 is built separately from the controller 180, the scope of the present disclosure is not limited thereto, and the memory 160 can be included in the controller 180.

The memory 160 as described above can include at least one type of storage media among a flash memory type, a hard disk type, a multimedia card micro type, a card-type memory (e.g., an SD or XD memory or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The multimedia device 100 can also be operatable in relation to web storage that performs the storage function of the memory 160 on the Internet.

The interface 170 serves as a passageway to all of the external devices connected to the multimedia device 100. The interface 170 receives data from the external device, receives power and transmits the power to each component inside the multimedia device 100, or allows the data inside the multimedia device 100 to be transmitted to the external device. For example, a wired/wireless headset port, an external charger port, a wired/wireless data port, a memory card port, a port to connect a device equipped with an identification module, an audio input/output (I/O) port, a video input/output (I/O) port, an earphone port, and the like can be included in the interface 170.

The interface can become a passageway through which, when the multimedia device 100 is connected to an external cradle, power from the cradle is supplied to the multimedia device 100 or a passageway through which various command signals input to the cradle by the user are transmitted to the multimedia device 100. The various command signals or the power input from the cradle can be operated as signals for recognizing that the multimedia device is correctly mounted on the cradle.

The controller 180 generally controls overall operations of the multimedia device and manages and controls the overall multimedia device 100, including the display, the memory, the sensor, the interface, and the like.

For example, the display device 100 can be controlled by the user command input via the user interface 130 or the internal program. In one example, the controller 180 can control the display 151 to display the video. In this regard, the video displayed on the display module 151 can be the still image or the moving image, and can be a 2D video or the 3D video. The controller 180 can also control the skin theme displayed on the device.

The controller 180 can be equipped with a multimedia module 181 for multimedia playback. The multimedia module 181 can be implemented within the controller 180 or can be implemented separately from the controller 180. Additionally, the controller 180 can have a skin system 182 for applying the skin theme. The skin system 182 can also be implemented within the controller 180 or can be implemented separately from the controller 180. The skin system 182 will be described in detail later.

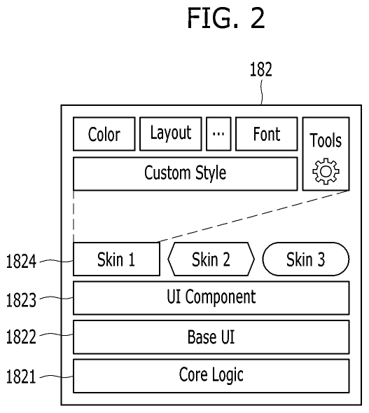

FIG. 2 is a block diagram showing a configuration of the skin system 182.

The skin system 182 is a type of software program and refers to a system that changes the skin, determines the function, and changes the theme easily via only simple manipulation of the interface.

The skin system 182 in the present disclosure has a function of creating the skin theme to be applied to the device and applying the created skin theme.

The skin system 182 can be implemented within the controller 180 or can be implemented separately from the controller 180.

The skin system 182 in the present disclosure can include a core logic block 1821, a base UI block 1822, a UI component block 1823, a skin block 1824, and the like. In this regard, the block refers to a program or software block stored in the multimedia device, is a bundle of code required to perform an operation, and refers to a section of software code or an algorithm of software programming. The block can contain one or more blocks.

More specifically, the core logic block 1821 can control a flow of a user event. Additionally, the base UI block 1822 can display basic elements of a component on the screen. The UI component block 1823 can play a role in constituting the screen.

The skin block 1824, which is a block that applies a UI style onto the component composed of the basic elements, can have several skin blocks so as to be selected based on input setting. The skin block 1824 can again include a detailed skin block and a customize block.

In other words, each skin block is composed of the detailed skin block and the customize block. Each skin block can be composed of components for screen style such as a font, a color, a layout, and a shape, and can provide a user interface, a pattern, and a tool for user definition.

Hereinafter, a flowchart of an embodiment to which the skin system 182 is applied will be described.

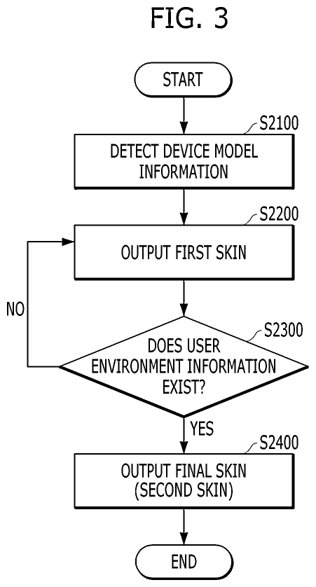

FIG. 3 is a flowchart briefly illustrating a method for controlling the skin system 182 according to an embodiment of the present disclosure.

As shown in FIG. 3, the method for controlling the skin system 182 first includes detecting a device model (s2100). For example, a model name of the device stored in the memory 160 can be detected.

The controller 180 outputs a first skin corresponding to the detected device model (s2200). In this regard, the first skin can be stored in advance along with the device model information in the memory 160.

The controller 180 determines whether user environment information exists using the sensor 140 or the like (s2300). In this regard, the user environment information includes surrounding environment information (a color, a brightness, and the like), exceptional situation information (e.g., a dangerous situation and the like), the user command (skin theme setting), and the like. Details will be described later.

When the user environment information exists, the controller 180 outputs a second skin corresponding thereto (s2400). When the user environment information does not exist, the first skin is output as it is. In other words, when the user environment information does not exist, the first skin is output as it is as a final skin.

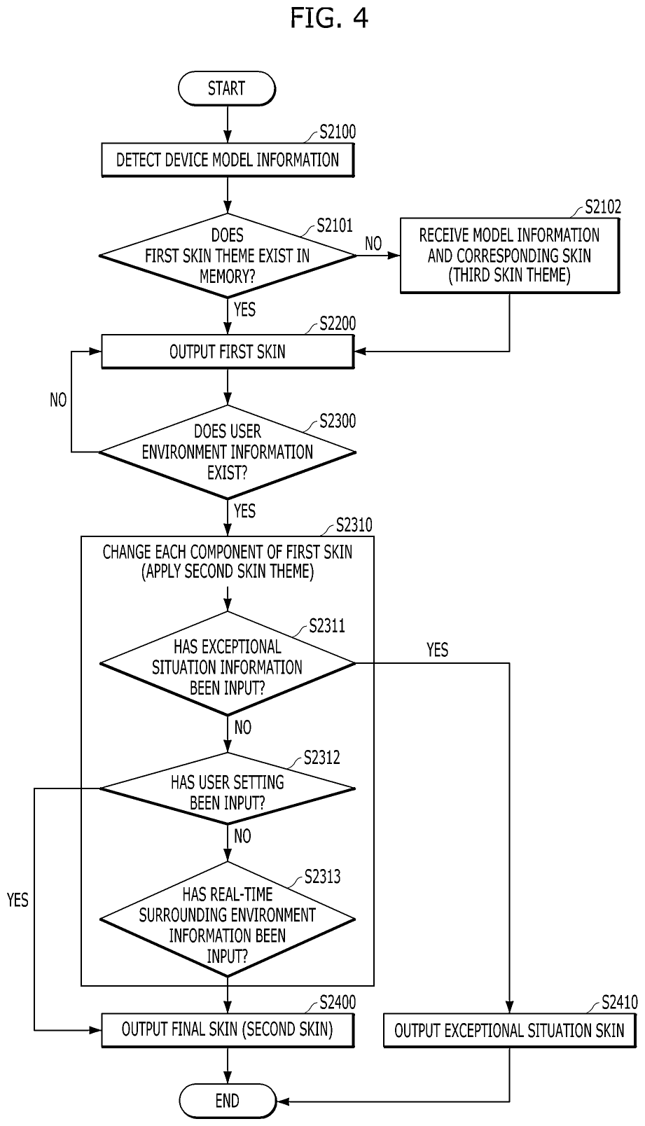

Hereinafter, embodiments of each step will be described in detail with reference to FIG. 4.

FIG. 4 is a flowchart illustrating in detail a method for controlling the skin system 182 according to an embodiment of the present disclosure.

The skin system 182 detects the model information of the multimedia device (s2100). Thereafter, whether the first skin theme corresponding to the detected model information is stored in the memory 160 is identified (s2101). When the corresponding first skin theme is stored, it is determined that model information exists. When the corresponding first skin theme is not stored, it is determined that model information does not exist.

In this regard, the memory 160 can store a database of the information on the various device models existing in the market. Additionally, each skin theme corresponding to each device model information can be stored in the memory 160. Additionally, the database can be updated via the network interface.

When it is determined that model information exists, as described above in FIG. 3, the first skin theme corresponding to the corresponding model information can be output (s2200).

When the model information does not exist, the model information and a third skin theme corresponding thereto can be received via the network interface (s2102). Thereafter, the third skin theme can be output as the first skin theme (s2200).

Thereafter, before outputting the first skin theme as the final theme, the controller 180 identifies whether the user environment information exists via the sensor 140 or the like (s2300).

The user environment information includes the exceptional situation information, the user command, and the surrounding environment information.

The exceptional situation information (e.g., the dangerous situation information and the like) can be input via the sensor 140. The user command can be input via the user interface. The user can set a desired value for a component whose value can be set among the components constituting the skin via the user interface 130. For example, a color, a font size, a high contrast, and the like can be set with the user command. The surrounding environment information can be input as the sensor 140 detects the surrounding operating environment in real time. The real-time surrounding environment information includes surrounding color information, surrounding brightness information, time, and the like. Details will be described later.

When the user environment information exists, a value of each component (a placement, a color, an icon, a font, a brightness, and the like) of the first skin can be changed to a value corresponding to each information (s2310). The skin system 182 synthesizes the changed values and outputs the final skin (the second skin) (s2400).

Hereinafter, first skin theme change (second skin theme application) (s2310) will be described. In this regard, the changes can be applied individually to the respective components of the skin.

First, whether a preset exceptional situation has been input is determined (s2311). As described above, the exceptional situation can be input via the sensor 140 or the like. In this regard, the exceptional situation, as a specific event, can include the dangerous situation, a cautionary situation, or the like that requires the user to be warned.

When the exceptional situation (specific event) information is input, an exceptional situation skin theme corresponding thereto is output (s2410). In the exceptional situation, a purpose of warning the user can be included, so that the exceptional situation takes precedence over the user command. For example, in a case of font size setting, in the exceptional situation, a warning phrase can be displayed with a preset size regardless of the user command or the surrounding environment information. A specific embodiment will be described later.

Next, when the exceptional situation information has not been input, whether the user command for user setting has been input is determined (s2312). As described above, the user command can be input via the user interface. The user can set the desired value for the component whose value can be set among the components constituting the skin via the user interface 130. For example, the color, the font size, the high contrast, and the like can be set to have desired values via the user command.

When there is the user command, a value corresponding thereto is applied to each component of the first skin theme. The applied values constitute the second skin, are applied with priority over values that change based on the real-time surrounding environment input, and are output in the final skin (s2400). For example, when a component of a background color among the components is set as a changeable component, even when the background color of the screen is set to blue in the first skin theme, the user can change the background color to a desired color (e.g., yellow). Alternatively, even when red is input depending on the surrounding environment, the color set by the user is output with priority. In this case, because the background color is the only setting that has been input by the user command, the background color set by the user is output as the component of the final skin (s2400). The background color is merely an example, the skin theme components can include the color, the font, the size, the high contrast, and the like, and the present disclosure can not be limited to the examples described.

Next, in a case of component without the user command, whether the real-time surrounding environment information has been input is determined (s2313). The real-time surrounding environment information includes the surrounding color information, the surrounding brightness information, the time, and the like, but this is merely an example, and the present disclosure is not limited thereto.

When the real-time surrounding environment has been input, a value of each skin theme component is changed to a value corresponding to the real-time surrounding environment. For example, when the red is detected in a surrounding interior, the skin theme can be changed to a skin theme with a red color scheme applied. Alternatively, when an illumination of the surrounding environment becomes lower, the skin theme can be changed to a skin theme with a dark color scheme applied.

Therefore, when the real-time surrounding environment has also not been input, because the change is not applied, the corresponding component will be output in the final skin, the same as that in the first skin. For example, the color will be described as one component of the skin theme. A pre-specified first color is applied based on the model information, a second color is applied in the exceptional situation, a third color is applied when it is not the exceptional situation and there is the user setting, and a fourth color that can change dynamically based on the real-time surrounding environment information input is applied when there is no user setting. When no exceptional situation information is input, no user setting is made, and no real-time surrounding environment is input, the pre-specified first color is output as it is.

The skin system 182 can output the final skin with such order (s2400). In other words, the final skin can be output by synthesizing the first skin theme corresponding to the device model information and the second skin theme corresponding in real time to the user environment information.

According to one embodiment of the present disclosure, in the process of synthesizing the first skin theme corresponding to the device model information and the second skin theme and outputting the final skin, the skin system 182 can limit a type or a scope of change of the component that responds to the user environment information in real time.

For example, the skin system 182 can not allow a hue value, a type of font, or a shape of the icon among the various components applied to the first skin theme to change or allow the changes thereof only within a certain range.

Additionally, according to one embodiment of the present disclosure, color information among the user environment information can be input in a form of HSB. The HSB is a method of expressing color with hue, saturation, and brightness. In particular, the hue can be expressed as a number from 0 to 360, and the saturation and the brightness can be expressed as a number from 0 to 100. For example, a hue value of 0 can represent red, 120 can represent green, and 240 can represent blue.

In addition, when specific color information is input in the form of HSB via external environment information, while preserving the input brightness and saturation information, the skin system 182 can allow the hue value to be changed only in a range of −10 to +10 from a hue value of the first skin theme.

For example, when the hue value of the first skin theme is 180 and the restricted range of hue change is 170 to 190, and when the hue value of the input color information is 90, a hue value of the final skin can be determined to 170, which is the nearest value among hue values within the hue change range.

Alternatively, when the hue value of the input color information is 90, because a relative position of 90 is one quarter of 360 in the range of 0 to 360 in which the hue value can be expressed, it can be calculated that the hue value corresponds to a relative position of 175 in the range of 170 to 190 and 175 can be selected as the hue value of the final skin.

With such limitations, the skin system 182 can provide the various final skins based on the user environment information while at least partially preserving aesthetics of the first skin theme that reflects design elements intended for the device model and the brand.

The order of determination can change for the exceptional situation information, the user command information, and the real-time surrounding environment information. However, for each skin component, priority is applied in the order of the exceptional situation, the user command, and the real-time surrounding environment, and therefore the skin system 182 determines the final skin by comprehensively considering all three information.

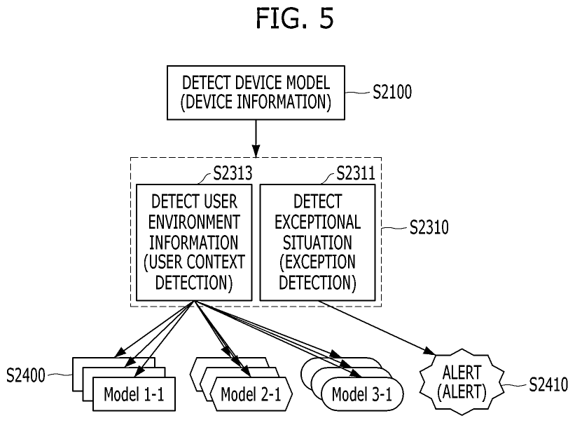

FIG. 5 shows a simplified order of information input and output in a method for controlling the skin system 182.

As described in FIGS. 3 and 4, the skin system 182 searches for and receives the device model information (S2100). The device model information includes, for example, the brand, the model name, and the like of the device product. The device model information can be stored in the memory 160 or the like. In this regard, the pre-specified skin can be stored along with the model information. In this regard, information on a model that does not correspond to the device or is not used and a pre-specified skin corresponding to such model can also be stored. In other words, with pre-specified skins for the various models all stored, the skin can be selectively applied based on the device model information.

The skin system 182 detects the user environment information, that is, the user command, the surrounding environment information (S2313), and the exceptional situation information (S2311), via the sensor 140, and then receives the corresponding information (S2310).

The user command includes, for example, user option setting, user custom setting, and the like. The surrounding environment information includes, for example, a product packaging color, a surrounding color of a usage environment, a lighting environment, a change in the surrounding environment when using the device, and the like. In this regard, the skin system 182 can first reflect the user command to create the skin and then reflect the surrounding environment information to the skin.

The exceptional situation information includes pre-specified exceptional situations in external and internal environments of the device. The pre-specified exceptional situations include, for example, a situation in which a speed of the device is detected to be equal to or higher than a preset speed or a situation in which an internal temperature of the device is detected to be equal to or higher than a preset temperature.

The skin system 182 outputs a final use screen skin, which changes based on the combination of the input device model information (S2100) and user environment information (S2310), (S2400). In other words, the final skin is determined by considering all the input information. In this regard, the applied information can have priority, but the priority is not essential.

The skin system 182 can output a warning screen or a screen with a warning skin applied when the exceptional situation is detected (S2410). For example, when the detected exceptional situation information, the speed of the device, is equal to or higher than the preset speed, a warning screen about the speed can be displayed, or a screen with a skin that emphasizes a speed-related component can be displayed.

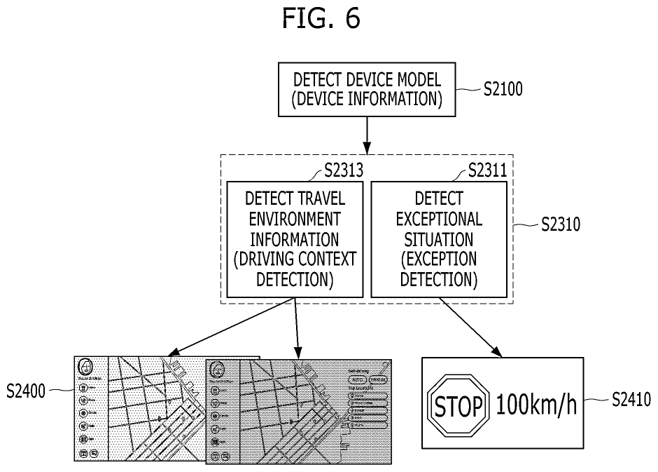

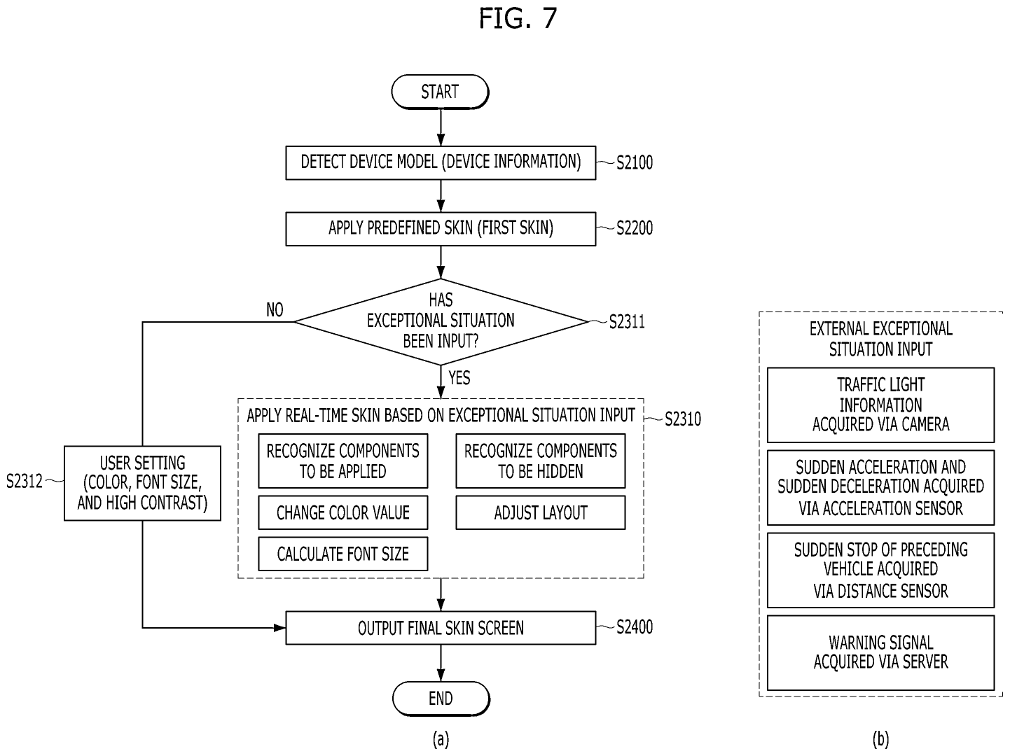

FIG. 6 shows an example of an embodiment in which external exceptional situation information is input when a device is a vehicle.

FIG. 6 is a flowchart illustrating dynamic skin (the second skin) application based on vehicle travel context (the user environment information) when the device is the vehicle, in one embodiment. For example, the skin system 182 can apply a dynamic skin change that emphasizes key information in response to a changing situation during vehicle operation with a single software block.

As described above in FIGS. 3 and 4, the skin system 182 first detects the device model information and applies the preset skin (the first skin) corresponding thereto (S2100). In the case of the vehicle, a vehicle model group is detected and a preset skin corresponding to such model is applied (S2100).

As described above, the skin system 182 applies the dynamic skin change (the second skin) in real time based on the user environment information (S2310).

In this regard, the user environment information includes travel environment information and the exceptional situation information. There can be priorities reflected depending on a type of detected information, but the priorities are not essential. The skin system 182 considers all the input information and outputs the final skin.

The skin system 182 detects the travel environment information via the sensor 140 (S2313). In one embodiment, a sudden stop situation ahead can be detected using a distance sensor. In this regard, a skin in a warning color (red) is applied to the UI of the screen (S2400). For other situations, a green tone skin can be applied.

The skin system 182 detects a user environment exceptional situation via the sensor 140 (S2311). The exceptional situation can include a sudden stop situation of a preceding vehicle, a speeding situation, and the like. When the exceptional situation is detected, a real-time skin based on the exceptional environment input is applied (S2410). In this regard, as one embodiment of the skin application, additional information (a map, a fuel efficiency, and the like) can not be displayed on the screen, the speed information can be displayed with an enlarged size, and a skin with a flashing warning tone can be applied. Additionally, speed and sign components can be expanded and a highly visible color can be applied. In other words, the skin system 182 that emphasizes only necessary UI can be applied.

(a) in FIG. 7 shows a flowchart of a case in which there is a user environment exceptional situation in a method for controlling the skin system 182 according to an embodiment of the present disclosure as an example.

As described above in FIGS. 3 and 4, the skin system 182 detects the model information of the multimedia device (s2100).

When it is determined that the model information exists, as described above in FIGS. 3 and 4, the preset first skin theme corresponding to the model information can be output (s2200).

The skin system 182 determines whether the preset exceptional situation has been input (s2311). As described above, the exceptional situation can be input via the sensor 140 or the like. The sensor 140 can include an external object sensor and an internal object sensor. In this regard, the exceptional situation, as the specific event, can include the dangerous situation, the cautionary situation, or the like that requires the user to be warned. When the exceptional situation (specific event) information is input, the exceptional situation skin theme corresponding thereto is applied (S2310).

According to another embodiment of the present disclosure, the skin system 182 can perform a gradual transition operation to the exceptional situation skin theme from the already applied skin theme when the exceptional situation information is expected to be generated even when the exceptional situation information has not been input.

For example, when the device temperature reaching a ° C. is set as the exceptional situation information for device overheating, and when the device temperature reaches (a-b° C.) with respect to a preset ‘b’ value, the skin system can determine that the generation of the exceptional situation information is expected and perform the gradual transition operation to the exceptional situation skin theme.

The gradual transition operation can include, for example, at least one of operations that the components displayed in the already applied skin theme move along a layout of the exceptional situation skin theme, vary in transparency or vary in a color or font properties (size and the like).

For example, when the device temperature reaching 80° C. (the ‘a’ value) is set as the exceptional situation information for the device overheating, from the time when it is detected that the device temperature has reached 60° C. (when the set ‘b’ value is 20), the color scheme of the skin theme can gradually transition to the red as the temperature approaches 80° C.

Referring to (b) in FIG. 7, the external exceptional situation can include, for example, traffic light information acquired via the camera, sudden acceleration and sudden deceleration acquired via the acceleration sensor, the sudden stop of the preceding vehicle acquired via the distance sensor, a warning signal acquired via the server, and the like. In other words, a red light, a light change, or departure of the preceding vehicle can be detected via the camera sensor, and the sudden stop situation of the preceding vehicle can be detected via the sensor 140. For example, when the device moves at the speed equal to or higher than the preset speed, the warning screen can be output.

Additionally, one embodiment can include a skin change based on recognition of the internal environment via the internal object sensor, application of the exceptional situation skin based on recognition of the external environment via the external object sensor, and the like. For example, when the exceptional situation occurs because of a change in the external situation, such as the sudden stop of the preceding vehicle, the speed and sign components can be enlarged, the highly visible colors can be applied, and other additional information components can be hidden.

Components applicable to the skin include not only the color but also display of UI information, the font size, and the like. Accordingly, the user can apply the skin system 182 that emphasizes only the necessary UI depending on the context.

Examples of applying the real-time skin based on the input of the exceptional situation information include selective application of a content to be displayed via recognition of components to be applied and components to be hidden, a color value change, layout adjustment, font size calculation, and the like (S2310).

In this regard, the components to be applied and the components to be hidden can also be determined depending on which sensor or combination of sensors the exceptional situation is input through.

For example, when the sudden acceleration and the sudden deceleration are sensed via the acceleration sensor, a speed component, a collision risk warning component, and the like can be set as the components to be applied, and GPS information, media content information, and the like can be determined as the components to be hidden.

In this regard, an importance ranking of each component can be set based on the exceptional situation of each specific sensor or combination of sensors, and the components to be applied and the components to be hidden can be set based on the importance ranking.

For example, when the device is the vehicle and the vehicle is traveling on a road with an 80 km/h limit, all GUIs of the skin theme can be output until the vehicle's travel speed reaches 70 km/h, GUIs up to the third most important GUI can be output at 80 km/h, GUIs up to the second most important GUI can be output at 90 km/h, and only the most important GUI can be output at 100 km/h. In this regard, processing to improve the visibility of the skin theme (e.g., at least one of size increasing, an animation effect, or a high contrast color) can also be performed.

Next, when the exceptional situation information has not been input, whether the user command for the user setting has been input is determined (s2312). As described above, the user command can be input via the user interface. The user can set the desired value for the component whose value can be set among the components constituting the skin via the user interface 130. For example, the color, the font size, the high contrast, and the like can be set to have the desired values via the user command.

When there is the user command, the value corresponding thereto is applied to each component of the first skin theme. The applied values constitute the second skin, and the value corresponding to the exceptional situation information input and the value corresponding to the user command input are combined with each other and output in the final skin (s2400).

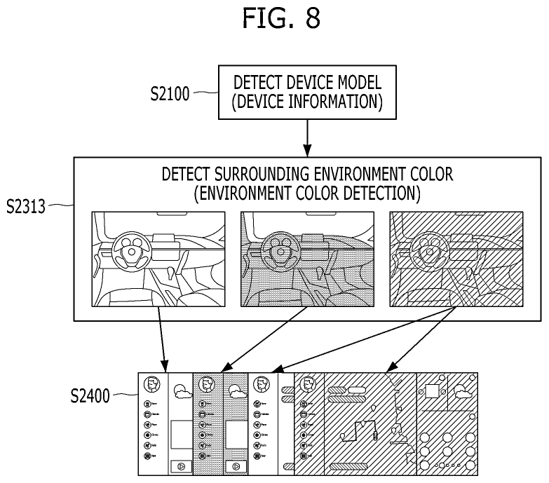

FIG. 8 shows an example of a flowchart of a method of applying, by the skin system 182, a skin when a device is a vehicle.

As described above in FIGS. 3 and 4, the skin system 182 receives the device information and outputs the preset skin (S2100). The device information includes, for example, a brand, a model, and the like of the vehicle. The skin system 182 can select and apply a corresponding preset skin (the first skin) based on the input information.

The skin system 182 detects the color of the surrounding environment via the sensor 140 (S2313). In this regard, an external color, surrounding brightness, and the like can be detected using the external object sensor. Additionally, a vehicle interior color, a seat color, an interior lighting color, interior brightness, and the like can be detected using the internal object sensor.

The skin system 182 compiles the information detected via the sensor 140 and outputs the final skin (S2400). For example, the final skin can have a UI composition corresponding to the vehicle model, and a color scheme corresponding to the vehicle interior color can be applied to the final skin.

In one embodiment, the skin system 182 can create a skin set by the user that matches the color tone (S2400). Because the color tone is input via the sensor 140, the user can respond to a change in the lighting color or the like without separate setting or code change.

In addition, as one embodiment, because the color tone and brightness are input via the sensor 140, even in a situation in which the surrounding brightness changes, such as a change in time or entering a tunnel under the same color tone, a real time response can be made without the separate setting.

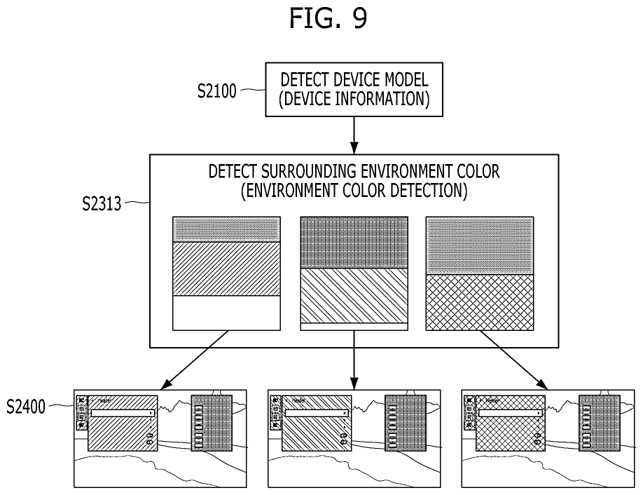

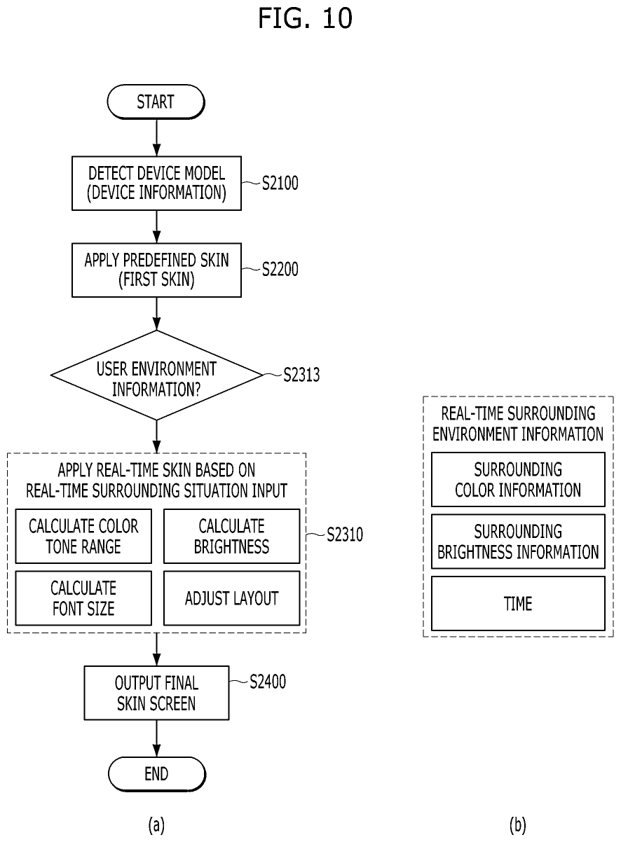

FIG. 9 illustrates an example of a flowchart in which the skin system 182 applies a skin when a device according to an embodiment of the present disclosure is a television (TV).

As one embodiment of the present disclosure, when the device is the television, the skin system 182 corresponding to packaging and user-selected customization for each product group or product within the group can be applied with one source code block.

As described above in FIGS. 3 and 4, the skin system 182 receives the device information and outputs the preset skin (S2100). The device information includes, for example, a TV product group, a product model name, and the like. The skin system 182 can apply a skin corresponding to the input information.

The skin system 182 can detect the color of the surrounding environment via the sensor 140 (S2313). The sensor 140 can include the external object sensor or the internal object sensor. When the device is the television, the internal object sensor can be deactivated and the external object sensor can be activated. For example, the product model packaging color, the wall color, and the like can be detected via the external object sensor.

The skin system 182 compiles the input information and applies the final skin (S2400). In this regard, a skin with a color scheme that matches the detected color tone can be applied. Because the color tone is input via the sensor 140, the color of the skin can respond not only to the product packaging, but also to the environment in which the device is placed, for example, a color of a wall in a space where the product is placed or a color of the lighting without the separate setting.

FIG. 10 shows a control flowchart of the skin system 182 as an embodiment when user environment information is input in a general situation rather than an exceptional situation.

(a) in FIG. 10 shows an example of a flowchart when real-time surrounding environment information is input in a method for controlling the skin system 182 according to an embodiment of the present disclosure.

(b) in FIG. 10 shows examples of what real-time surrounding environment information can contain that can be input in a method for controlling the skin system 182 according to an embodiment of the present disclosure.

The skin system 182 detects the model information of the multimedia device (s2100).

When it is determined that the model information exists, as described above in FIGS. 3 and 4, the first skin theme corresponding to such model information can be output (s2200).

Thereafter, the skin system 182 detects the user environment information (S2313) and applies the changes to the skin (S2310). The user environment information can include the real-time surrounding environment and the user setting. Referring to (b) in FIG. 10, the real-time surrounding environment can include surrounding color information, surrounding brightness information, time, and the like. Referring to (a) in FIG. 10, the real-time skin application (S2310) based on the real-time surrounding environment input can include color tone range calculation, brightness calculation, font size calculation, layout adjustment, and the like.

When there is the user command, as described above in FIG. 4, the value corresponding thereto is applied to each component of the first skin theme. The applied values can constitute the second skin, and can be applied with priority over the values that change based on the real-time surrounding environment input, but the priority is not essential. The skin system 182 compiles the input user environment information and creates and outputs the final skin (s2400).

It is obvious to those skilled in the art that the present disclosure can be embodied in other specific forms without departing from the essential characteristics of the present disclosure.

The above detailed description should not be construed as restrictive in any respect and should be considered illustrative. The scope of the present disclosure must be determined by reasonable interpretation of the attached claims, and all changes within the equivalent scope of the present disclosure are included in the scope of the present disclosure.

What is claimed is:

1. A multimedia device comprising:
a display;
a sensor configured to detect surrounding environment information around the multimedia device;
a controller; and
a memory storing instructions thereon, which when executed by the controller, cause the controller to:
determine whether device model information is stored in the memory;
display, via the display, a first skin theme based on the determination of whether device model information is stored in the memory; and
change to displaying a second skin theme corresponding to the surrounding environment information sensed in real time by the sensor.

2. The multimedia device of claim 1, wherein execution of the stored instructions further cause the controller to:
receive the device model information and a third skin theme corresponding thereto via a network interface based on a determination that the device model information is not stored in the memory,
wherein the displayed first skin theme corresponds to the received third skin theme.

3. The multimedia device of claim 1, wherein execution of the instructions further cause the controller to execute a skin system,
wherein the skin system includes:
an UI component block configured to construct a screen;
a logic block configured to control user event flow; and
a customize block,
wherein the customize block is configured to allow a user to define at least one of a font, a color, a layout, or a shape of a skin theme.

4. The multimedia device of claim 1, wherein execution of the stored instructions further cause the controller to:
change to displaying an exceptional situation skin theme based on a specific event detected by the sensor.

5. The multimedia device of claim 4, wherein at least some options of the exceptional situation skin theme are not changed according to a user command.

6. The multimedia device of claim 4, wherein the at least some options of the exceptional situation skin theme are determined based on a type of sensor or a type of combination of sensors related to the specific event.

7. The multimedia device of claim 1, further comprising a user interface for receiving a user command,
wherein at least one option of the first skin theme is changed based on the user command received via the user interface.

8. The multimedia device of claim 1, wherein the surrounding environment information includes at least one of brightness, a color value, an interior material, an interior, a temperature value, weather information, position information, or time information.

9. The multimedia device of claim 1, wherein the sensor further includes an external object sensor and an internal object sensor,
wherein the external object sensor and the internal object sensor are each controlled based on a type of the multimedia device.

10. A method for controlling a multimedia device, the method comprising:
determining whether device model information is stored in a memory;
displaying, via a display, a first skin theme based on the determination of whether device model information is stored in the memory; and
changing to display a second skin theme corresponding to surrounding environment information sensed in real time by a sensor.
